(19) United States
(12) Patent Application Publication
(10) Pub. No.: US 2010/0171826 A1
(43) Pub. Date: Jul. 8, 2010

(54) METHOD FOR MEASURING RETAIL DISPLAY AND COMPLIANCE

(75) Inventors: Craig Hamilton, Nashville, TN (US); Wayne Spencer, Charlestown, MA (US); Alexander Ring, Allentown, PA (US); Peter L. Pastor, Sherman Oaks, CA (US); Donald E. Campbell, Sterrett, AL (US)

Correspondence Address: COOPER & DUNHAM, LLP, 30 Rockefeller Plaza, 20th Floor, NEW YORK, NY, 10112, US

(73) Assignee: STORE EYES, INC., Sherman Oaks, CA (US)

(21) Appl. No.: 12/225,751

(22) PCT Filed: Feb. 28, 2007
(86) PCT No.: PCT/US07/05169

§ 371 Date: Oct. 2, 2009

(30) Foreign Application Priority Data
Apr. 12, 2006 (US) PCT/US2006/013703

(51) Int. Cl. H04N 7/18

(52) U.S. Cl. 348/135; 348/E07.085

(57) ABSTRACT

Method and apparatus for measuring retail store display and shelf compliance are provided. A mobile capture unit, (21), determines a movement distance and moves the mobile capture unit, (21), the determined movement distance. The mobile capture unit, (21), captures one or more images of one or more product displays, (22), product shelves or products with the mobile image capture unit (21), using one or more cameras.

### REFERENCE TO RELATED APPLICATIONS

This is a continuation-in-part of PCT/US2006/013703, filed on Apr. 12, 2006, which is based on and claims the benefit of Provisional Application 60/670,802 filed Apr. 13, 2005, entitled “Method And System For Automatically Measuring Retail Store Display Compliance”, the entire contents of which are herein incorporated by reference.

### BACKGROUND

1. Field of the Invention

The present disclosure relates generally to the field of consumer product sales and, more particularly, to a method and apparatus for measuring retail store display and shelf compliance through automated, digital image capture and analysis.

2. Background of the Invention

Sales of consumer products have been shown to increase dramatically with the use of large displays set up in secondary locations in high traffic areas of a retail store in comparison with sales of the same product sold directly from their primary shelf location. As a result, manufacturers spend billions of dollars annually purchasing display space in retail stores in the form of, for example, end-of-aisle displays, stand-alone displays, point-of-sale displays, pallet displays, etc. In some instances, manufacturers may pay retailers a fee for the prime placement of products in grocery stores or supermarkets for specified periods of time to facilitate the products sale, for example, shelves at eye level or at end-of-aisle displays.

To ensure that the retailer is adequately showcasing its product and display, a manufacturer typically sends its personnel or an independent auditor to visit the retail location. The auditor verifies whether or not the display has been set up in a manner satisfactory to and paid for by the manufacturer. However, the problem with such audits is that they normally are done on a sample basis, usually less than 10% of the total market. The frequency of the audits is very limited, no more than once a week. For example, it is expensive and difficult to regularly inspect hundreds of chains of retail stores, especially if they are located all over the country. Results are then projected for a chain or market based on this small sample. Because items in grocery stores, for example, have a high rate of turns, displays change from day to day, which makes the current method of reporting not a fair representation of the actual store conditions.

Manufacturers often find themselves paying billions of dollars for retail display and shelf space with no adequate way to ensure that retail stores are in fact merchandising their promoted products in the location and for the amounts of time for which payment has been made. Accordingly, there is a need for a reliable and efficient way to audit retail store display and shelf compliance.

### SUMMARY

A method for measuring retail store display and shelf compliance, according to one embodiment of the present invention, includes (a) verifying a starting location of a mobile image capture unit, (b) determining a movement distance for the mobile image capture unit, (c) moving the mobile capture unit the determined movement distance, (d) capturing one or more images of one or more product displays, product shelves or products with the mobile image capture unit, (e) determining if there are more images to capture, (f) repeating steps (b) through (e) if it is determined that there are more images to capture, and (g) processing the one or more captured images if it is determined that there are no more images to capture.

An apparatus for measuring retail store display and shelf compliance, according to one embodiment of the present invention, includes a unit for determining a movement distance for the mobile image capture unit, a unit for moving the mobile capture unit the determined movement distance, one or more cameras for capturing one or more images of one or more product displays, product shelves or products with the mobile image capture unit, a central processing unit for determining if there are more images to capture and processing the one or more captured images, a user interface, and a power source.

A method for measuring retail store display and shelf compliance, according to one embodiment of the present invention, includes, capturing one or more images of one or more retail store conditions, associating the one or more captured images with related information, transmitting the one or more captured images and the related information to a processing location for storage and processing, receiving the one or more captured images and the related information at the processing location and storing the one or more captured images and related information in a repository, processing the one or more captured images, comparing the one or more retail store conditions in the one or more captured images with a library to identify the one or more retail store conditions and obtain identification information about the one or more retail store conditions, storing the one or more identified captured images and identification information for the one or more retail store conditions in the repository, analyzing the one or more retail store conditions in the one or more captured images and identification information, and generating one or more summary reports or one or more alerts based upon the analysis.

A system for measuring retail store display and shelf compliance, according to one embodiment of the present invention, includes, an image capture unit for capturing one or more images of one or more retail store conditions, means for associating the one or more captured images with related information, means for transmitting the one or more captured images and the related information; and a processing location including means for receiving the one or more captured images and related information, means for processing the one or more captured images, an image recognition module for comparing the one or more retail store conditions in the one or more captured images with a library to identify the one or more retail store conditions and obtain identification information about the one or more retail store conditions, a repository for storing the one or more identified captured images and identification information; and a reporting engine for analyzing the one or more retail store conditions in the one or more captured images and identification information and generating one or more summary reports or one or more alerts based upon the analysis.

A computer storage medium, including computer executable code for measuring retail store display and shelf compliance, according to one embodiment of the present invention, includes, code for capturing one or more images of one or more retail store conditions, code for associating the one or more captured images with related information, code for transmitting the one or more captured images and the related information to a processing location for storage and processing, code for receiving the one or more captured images and the related information at the processing location and storing the one or more captured images and related information in a repository, code for processing the one or more captured images, code for comparing the one or more retail store conditions in the one or more captured images with a library to identify the one or more retail store conditions and obtain identification information about the one or more retail store conditions, code for storing the one or more identified captured images and identification information for the one or more retail store conditions in the repository, code for analyzing the one or more retail store conditions in the one or more captured images and identification information, and code for generating one or more summary reports or one or more alerts based upon the analysis.

A computer storage medium, including computer executable code for measuring retail store display and shelf compliance, according to one embodiment of the present invention, includes, code for identifying and verifying the location of the apparatus, code for capturing one or more images of one or more retail store conditions, code for storing the one or more captured images of the one or more retail store conditions, code for processing the one or more captured images of the one or more retail store conditions, code for transmitting the one or more captured images of the one or more retail store conditions to a processing location, and code for generating a confirmation indicating whether the one or more captured images of the one or more retail store conditions were successfully sent to the processing location.

### BRIEF DESCRIPTION OF THE DRAWINGS

The features of the present application can be more readily understood from the following detailed description with reference to the accompanying drawings wherein:

FIG. 1 is a block diagram of an exemplary computer system capable of implementing the method and system of the present invention;

FIG. 2A is a block diagram illustrating a system for measuring retail store display and shelf compliance, according to one embodiment of the present invention;

FIG. 2B is a flow chart illustrating a method for measuring retail store display and shelf compliance, according to one embodiment of the present invention;

FIG. 2C is a block diagram illustrating a mobile capture unit, according to one embodiment of the present disclosure;

FIG. 2D is a flow chart illustrating a method for measuring retail store display and shelf compliance, according to one embodiment of the present disclosure;

FIG. 2E is a block diagram illustrating a mobile capture unit, according to one embodiment of the present disclosure;

FIG. 2F is a flow chart illustrating the step of processing the one or more captured images, according to an embodiment of the present disclosure;

FIG. 2G is a block diagram illustrating a mobile capture unit, according to one embodiment of the present disclosure;

FIG. 2H is a block diagram illustrating a mobile capture unit, according to one embodiment of the present disclosure;

FIG. 2I is a block diagram illustrating a mobile capture unit, according to one embodiment of the present disclosure;

FIG. 3A is a block diagram illustrating a mobile capture unit, according to one embodiment of the present disclosure;

FIG. 3B is a flow chart illustrating a method for capturing one or more images, according to one embodiment of the present disclosure;

FIG. 4 is a block diagram illustrating the main screen of the mobile capture unit, according to one embodiment of the present disclosure;

FIG. 5 is a block diagram illustrating the detailed screen of the mobile capture unit, according to one embodiment of the present disclosure;

FIG. 6 is a flow chart illustrating the step of processing by the image recognition module, according to an embodiment of the present disclosure;

FIG. 7 is a sample report generated by using the method for measuring retail store display and shelf compliance, according to one embodiment of the present invention;

FIG. 8 is a sample report showing display and shelf compliance by store generated by using the method for measuring retail store display and shelf compliance, according to one embodiment of the present invention;

FIG. 9 is a sample report showing display and shelf compliance at the district level, generated by using the method for measuring retail store display and shelf compliance, according to one embodiment of the present invention;

FIG. 10 is a sample report showing display and shelf compliance at the division level, generated by using the method for measuring retail store display and shelf compliance, according to one embodiment of the present invention;

FIG. 11 is a sample report showing display and shelf compliance at a retailer level, generated by using the method for measuring retail store display and shelf compliance, according to one embodiment of the present invention; and

FIG. 12 is a sample report showing display and shelf compliance by competitive brand, generated by using the method for measuring retail store display and shelf compliance, according to one embodiment of the present invention.

### DETAILED DESCRIPTION OF THE PREFERRED EMBODIMENTS

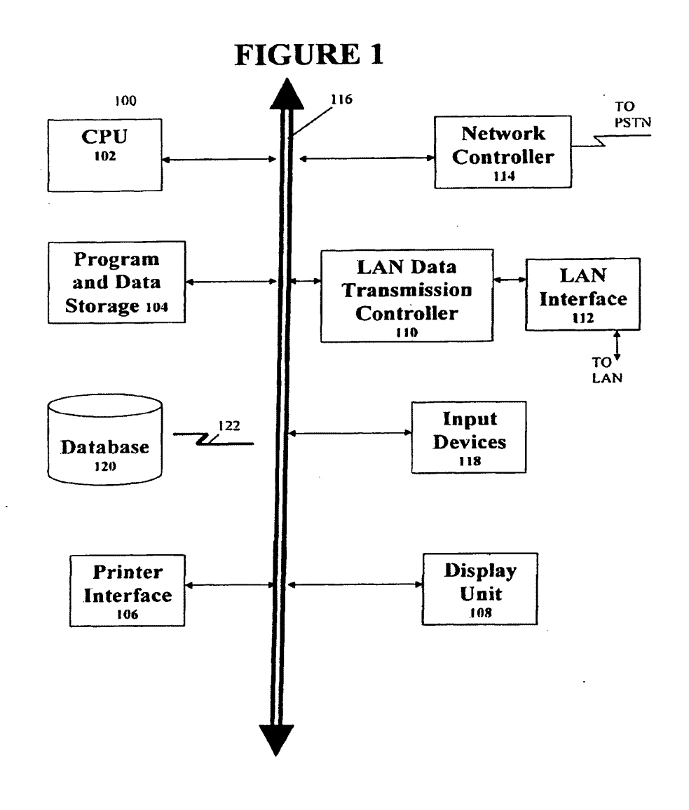

The present invention provides tools (in the form of methodologies and systems) for measuring retail store display and shelf compliance through automated, digital image capture and analysis. FIG. 1 shows an example of a computer system 100 which may implement the method and system of the present invention. The system and method of the present invention may be implemented in the form of a software application running on a computer system, for example, a mainframe, personal computer (PC), handheld computer or server. The software application may be stored on a recording medium locally accessible by the computer system, for example, floppy disk, digital video or compact disk, optical disk, firmware memory, or magnetic hard disk, or may be remote from the computer system and accessible via a hard wired or wireless connection to a network (for example, a local area network, or the Internet) or another transmission medium.

The computer system 100 can include a central processing unit (CPU) 102, program and data storage devices 104, a printer interface 106, a display unit 108, a wired or wireless (LAN) local area network data transmission controller 110, a LAN interface 112, a network controller 114, an internal bus 116, and one or more input devices 118 (for example, a keyboard or a mouse). As shown, the system 100 may be connected to a database 120, via a link 122.

The use of an image capture unit provides a means to regularly, throughout the day, scan and monitor displays set up in retail stores. The method and system of the present disclosure may capture and store digital images of retail store conditions, for example, pictures of displays, shelf conditions and/or products of multiple retail outlets. These captured images may be stamped with date, time and location information before they are electronically saved and/or sent, for example, via the Internet, to the processing location, which may be a central processor. The captured images may then be matched up to entries in a library or database to identify the products on display. Not only can the products be identified, but the amount of product that is packed out on a display may be approximated. Display activity may be summarized in reports and made available to the manufacturer participants or retailers, for example, in an electronic format or report format. For example, manufacturers may peruse through multiple levels of the hierarchy of the reporting to see photos of the displays on which reports have been issued.

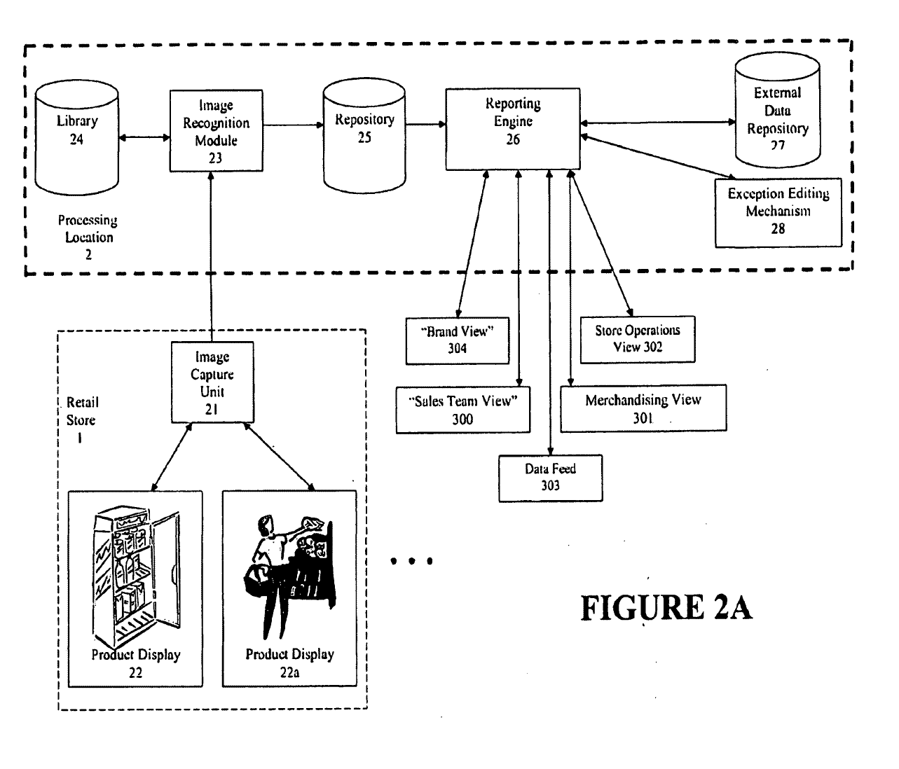

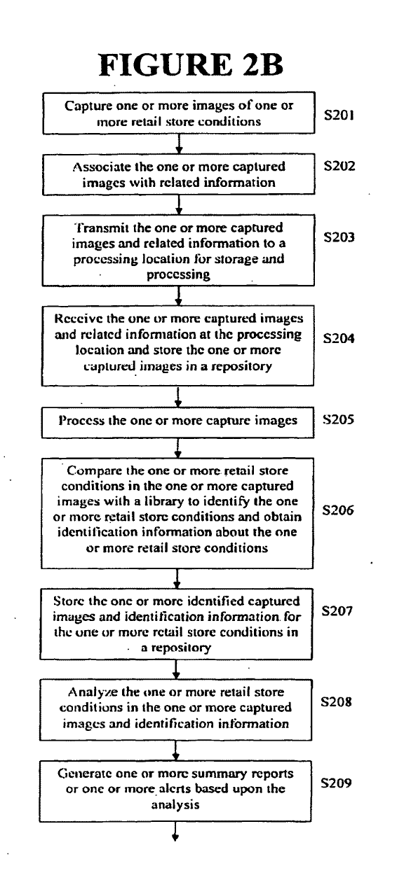

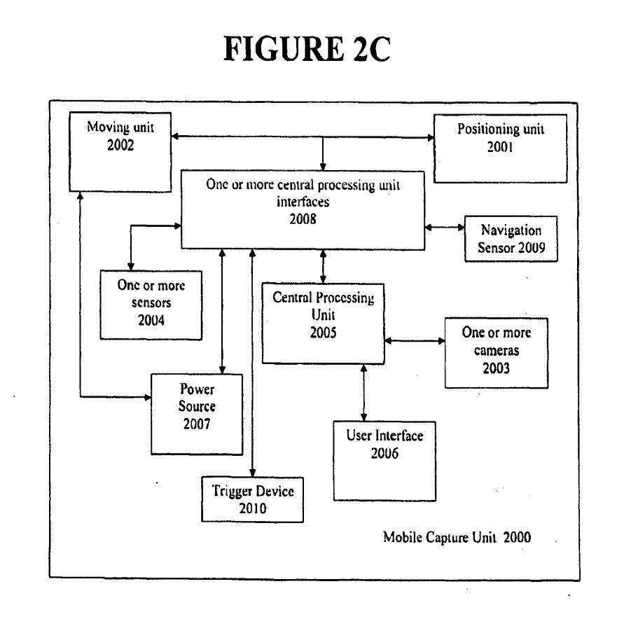

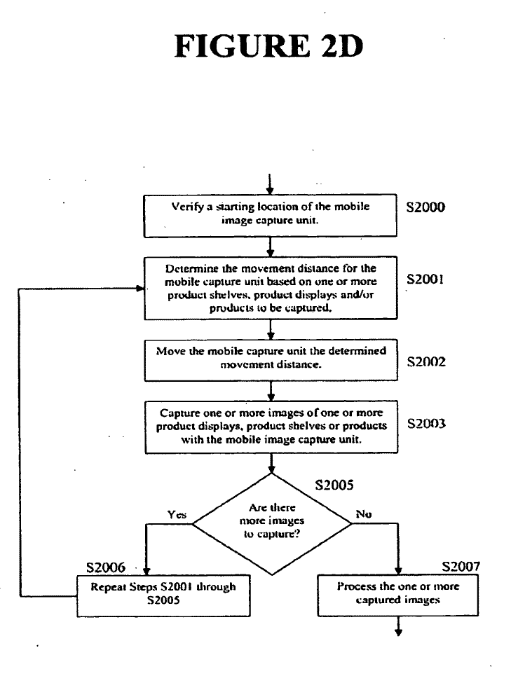

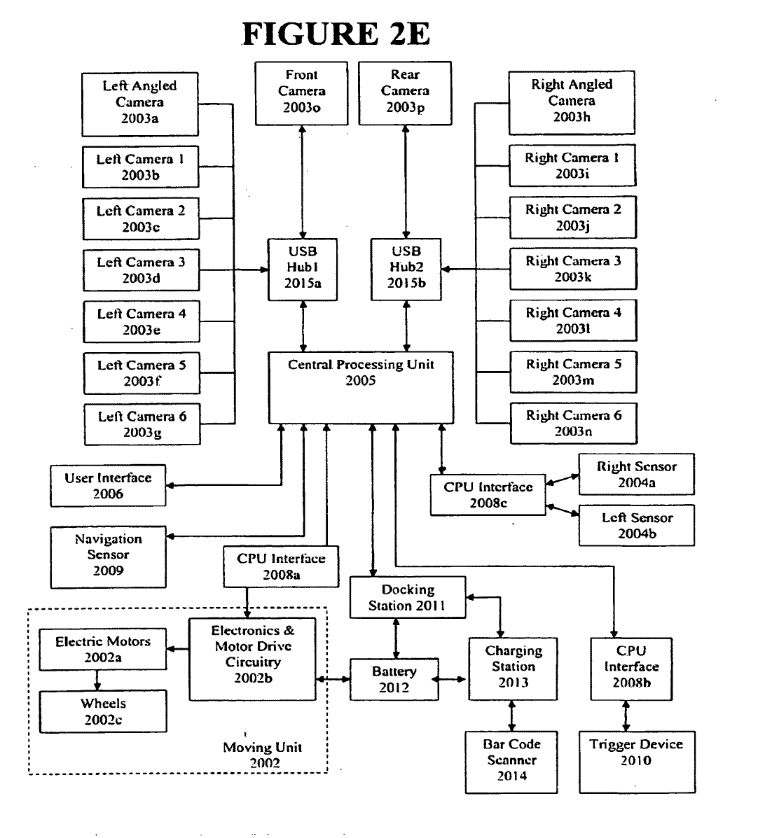

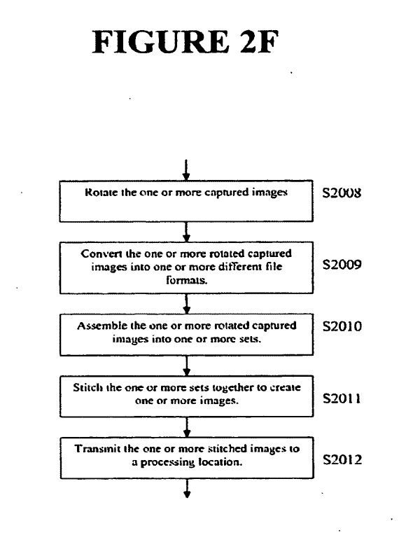

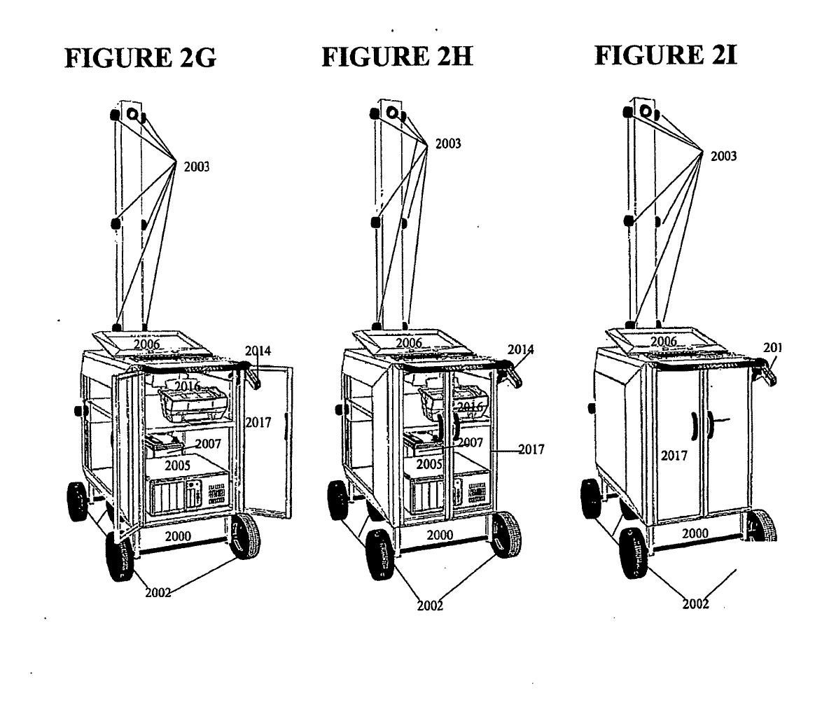

A system for measuring retail store display and shelf compliance through automated, digital image capture and analysis, according to one embodiment of this invention, will be discussed with reference to FIG. 2A. The system 20 includes an image capture unit 21, product display 22, product display 22a, image recognition module 23, a library 24, a repository 25, and reporting engine 26. The image capture unit 21 may be used at a retail store 1 containing one or more product displays 22. The processing location 2 includes the image recognition module 23, the library 24, the repository 25, the reporting engine 26, external data repository 27 and exception editing mechanism 28. The reporting engine 26 may be used in connection with external data 27 and an exception editing mechanism 28; to generate one or more reports and/or alerts. For example, the reports may be in the form of a brand view 304, a sales team view 300, a merchandising view 301, a store operations view 302 and/or a standard electronic data feed 303.

A method for measuring retail store display and shelf compliance, according to one embodiment of the present invention, will be discussed below with reference to FIGS. 2A and 2B. The image capture unit 21 captures images of, for example, manufacturers' product displays 22, 22a and other retail store conditions within a retail store 1 (Step S201). The image capture unit 21 may include the following devices, which will be described in further detail below: in-store security cameras, camera phones, fixed video or other digital cameras, moving video or other digital cameras (e.g., a camera mounted in a moving track that moves from one area of the store to another), web cameras, a mobile capture unit, a mobile cart and/or a self-propelled robot. The one or more captured images are associated with related information, such as date, time and location information (Step S202) (e.g., Store Name, Store Location, Display Location, Display Type, Date and Time of Image Capture) and both the captured images and the related information are transmitted from the image capture unit 21 to a processing location 2 for storage and processing (Step S203). This can be either through hard wire or wireless connections from the image capture unit 21.

The processing location 2 receives the one or more captured images and related information and stores the one or more captured images in a repository 25 (Step S204). The image recognition module 23 processes the one or more captured images determining whether the images are of sufficient quality and whether or not they contain sufficient content (Step S205). To identify the one or more retail store conditions in the one or more captured images, the image recognition module 23 compares the one or more retail store conditions against a library 24 and matches each retail store condition with, for example, a product. The image recognition module 23 also obtains identification information about each retail store condition (Step S206). For example, the identification information may include Store Name, Store Location, Display Location, Display Type, Date and Time of Image Capture, Display Quantity, Universal Product Code (“UPC”), Brand, Description, Size, Category, etc. The one or more identified captured images and identification information are then stored in the repository 25 (Step S207).

The reporting engine 26 analyzes and compiles the information stored in the repository 25 together with other external data repository 27 (for example, sales information, inventory information) and generates a summary of the information and/or one or more alerts (Steps S208 & S209). The summary may be provided in a report format and/or an electronic data feed format into the manufacturer's or retailer's internal reporting system. For example, a raw picture feed and/or a raw data feed of one or more retail store conditions may be provided. The reporting engine 26 may also provide automated alerts when one or more retail store conditions are met or exceeded. These alerts may be sent via a telecommunications link, such as by email. For example, if only a certain number of a specific product is remaining on the shelf of a retail store, the reporting engine may generate and send an automatic email alert to, for example, the manufacturer. The reporting engine 26 can also compile information in different views for different users. For example, a brand view 304, sales team view 300, merchandising view 301 and/or a store operations view 302. Moreover, the reporting engine 26 can provide access to any captured image in any retail store at any location within the retail store for any given time.

### Image Capture Unit

### a) Ad-Hoc Approach

According to an embodiment of the present disclosure, images may be captured by using an ad-hoc approach that may include the use of one or more of the following devices: in-store security cameras, camera phones, web cameras, fixed video or other digital cameras, and moving video or other digital cameras. For example, images of the retail store conditions, such as the displays and shelves, may be taken with digital cameras and/or camera phones and can be emailed to the processing location for storage and processing. Images taken using the ad-hoc approach may be stored in a repository 25 for ad-hoc viewing. The processing location 2 may include an Internet or World Wide Web based portal for uploading the images that are taken by cell phones, for example. This portal may include a user identification and password to prevent unauthorized access, a data entry screen to capture key data for the reporting of each image, including store, location, description, etc. and the ability to upload the pictures and queue them up for processing and storage. When transmitted, these images include related information, such as, retail store identification, text description of the picture's location in the retail store, etc. According to an embodiment of the present disclosure, prior to the transmission of the images captured using the ad-hoc image capture approach, the images should be scanned for potential computer viruses, worms, etc.

### b) Mobile Capture Unit

According to another embodiment of the present disclosure, the image capture unit 21 is a mobile capture unit. The mobile capture unit may be for example, a portable unit that is easy to transport and enables users to carry it from store to store or it may be a more substantial unit in the form of, for example, a cart with wheels (similar in size to a shopping cart), that enables users to capture images by easily pushing it through the aisles in a store. For example, the mobile capture unit in the form size similar to a shopping cart may be useful in stores that do not utilize carts whereas a portable unit would be used in stores that have narrow aisles where carts may not be deployed. The mobile capture unit may be self-propelled (for example, by using electric motors) and should contain a battery supply and be rechargeable. When not being used, the portable mobile capture unit will enter a stand-by mode. When the mobile capture unit has finished capturing images of the retail store conditions, audible or visual indications may be emitted from a speaker or shown on a display as a reminder to plug the unit into a power source to recharge its batteries.

A mobile capture unit for measuring retail store display and shelf compliance, according to one embodiment of this invention, will be discussed with reference to FIG. 2C. The mobile capture unit 2000 includes positioning unit 2001, moving unit 2002, one or more cameras 2003 (for example, one or more digital cameras, video cameras, web cameras etc.), one or more sensors 2004 (for example, infrared or other distance measuring sensors), a central processing unit 2005 (for example, industrial computer, laptop computer, desktop computer, personal digital assistant, microcontroller etc.), a user interface 2006 (for example, graphical user interface, touch-screen monitor, keyboard with monitor, mouse with monitor and/or any other data acquisition/entry device etc.), a power source 2007 (for example, one or more rechargeable batteries, fuel cell, etc.), one or more central processing unit interfaces 2008, a navigation sensor 2009 and a triggering device 2010 (for example, a digital encoder equipped wheel). The central processing unit 2005 provides the control for the positioning unit 2001, moving unit 2002, one or more cameras 2003, one or more sensors 2004, user interface 2006, power source 2007, navigation sensor 2009 and triggering device 2010. A user interface 2006 may be used by a user to input and receive data in order to control the mobile capture unit 2000. The power source 2007, such as a rechargeable battery or fuel cell, is used to power the mobile capture unit 2000.

According to an embodiment, the central processing unit 2005 provides the control through one or more central processing unit interfaces 2008 for the positioning unit 2001, the moving unit 2002, the one or more sensors 2004, the power source 2005 and/or the triggering device 2010. The one or more central processing unit interfaces 2008 may be used as the data acquisition electronic interfaces between the central processing unit 2005 and the power source 2007, the one or more sensors 2004, positioning unit 2001, moving unit 2002 and/or trigger device 2010. According to an embodiment, one or more central processing unit interfaces 2008 may be utilized for each component, for example, five different central processing unit interfaces 2008 may be utilized for the power source 2007, the one or more sensors 2004, positioning unit 2001, moving unit 2002 and triggering device 2010.

The triggering device 2010, such as a digital encoder equipped wheel or hall effect or similar device, may be used to detect the rotation of a wheel in order to determine the actual movement distance and send a signal to the central processing unit 2005 through a central processing unit interface 2008, for example. The triggering device 2010 can control the timing of the image capture by measuring the total distance traveled by the mobile capture unit 2000, for example, by counting the revolutions of the digital encoder equipped wheel. According to an embodiment of the present disclosure, the number of revolutions of the trigger wheel can be used by the central processing unit 2005 to determine if the mobile capture unit 2000 is moving too fast to obtain optimum picture quality. If the central processing unit 2005 determines that the mobile capture unit 2000 is moving too fast, it can provide an alert to the user and/or automatically adjust the speed of the unit via feedback circuitry to a slow pace.

The moving unit 2002 for moving the mobile capture unit 2000 may comprise one or more electric motors coupled to one or more wheels to automatically propel the mobile capture unit 2000. The one or more electric motors are controlled by electronics and motor drive circuitry using various methods known in the art. The electronics and motor drive circuitry is controlled by the central processing unit 2005 of the mobile capture unit 2000 through a central processing unit interface 2008. For example, the electric motors can be used for forward, reverse, and steering motion of the mobile capture unit 2000 under the control of the central processing unit 2005.

According to an embodiment, the mobile capture unit 2000 comprises a navigation sensor 2009 that identifies the bearing, location and movement of the mobile capture unit 2000 for in-store navigation and mapping. For example, the mobile capture unit 2000 may use one or more radio frequency identification (“RFID”) readers, one or more GPS sensors, digital or analog compasses, and/or one or more special ultra-violet sensors that can detect marker tags made of a special film that is detectable only through ultra-violet light to determine the location and movement of the mobile capture unit 2000.

According to an embodiment, the mobile capture unit 2000 comprises a bar-code scanner that allows the mobile capture unit 2000 to read the UPC codes on one or more products. The bar-code scanner may be a wired or wireless hand-held scanner to be operated by a user, or it may be a scanner built into the mobile capture unit 2000 to allow the unit to automatically scan the bar codes. The central processing unit 2005 receives data from the bar-code scanner and may store it. A docking station is used to connect the bar-code scanner to the mobile capture unit 2000. The docking station comprises a docking connector, serial port and a wireless link connecting the bar-code scanner to the mobile capture unit 2000. According to an embodiment, the docking station may also be used to connect the rechargeable battery to a battery charging system. An electronic compass may also be provided, allowing the user to obtain the real-time bearing status of the mobile capture unit 2000 versus the earth's magnetic field.

A method for measuring retail store display and shelf compliance, according to one embodiment of the present invention, will be discussed below with reference to FIGS. 2C and 2D. The starting location of the mobile capture unit 2000 can be identified and confirmed by using, for example, radio frequency identification, GPS identification, bearing information, and/or ultra-violet sensing technologies. (Step S2000). The positioning unit 2001 determines the appropriate movement distance for the mobile capture unit 2000 based on one or more product shelves, product displays and/or products to be captured. (Step S2001). The moving unit 2002 moves the mobile capture unit 2000 the determined movement distance (Step S2002). The one or more cameras 2003 capture one or more images of the one or more product shelves, product displays and/or products (Step S2003). According to an embodiment, the one or more images may be captured while the mobile capture unit 2000 is moving. The one or more sensors 2004 determine an object distance between the mobile capture unit 2000 and the one or more product displays, product shelves, and/or products (Step S2004). The central processing unit 2005 determines if there are any more images to capture (Step S2005). If it is determined that there are more images to capture (Yes, go to Step S2005), Steps S2001-S2005 are repeated (Step S2006). If it is determined that there are no images remaining to be captured (No, Step S2005), the central processing unit 2005 processes the one or more captured images (Step S2007).

According to one embodiment, the mobile capture unit 2000 described in FIGS. 2C and 2D is designed to capture and store individual images from the one or more cameras 2003 when appropriate so as to reduce the amount of hard disk space required for saving imagery of very large areas. As a result, the mobile capture unit 2000 automatically determines the appropriate distance to travel for image capture. In other words, the mobile capture unit 2000 determines where the pictures must overlap so that images may be “stitched” together. The movement distance that the mobile capture unit 2000 moves for each image capture may be automatically determined by the central processing unit 2005. For example, the central processing unit 2005 may calculate the optimum horizontal and vertical overlap that is required for stitching the images captured together to create a complete panoramic view from multiple images. This may be based on the distance of the product shelves, product displays and/or products to be captured from the mobile capture unit 2000. The distance of the product shelves, product displays and/or products to be captured may be measured using the one or more sensors 2004. For example, the mobile capture unit 2000 may unitize multiple infrared and/or ultrasonic sensors to measure and record the distance between the mobile capture unit and the product shelves, product displays, and/or other products within each retail store. According to an embodiment, the mobile capture unit may utilize a left infrared and/or ultrasonic sensor to measure the distance between the mobile capture unit and product displays, product shelves, and/or products on the left side of the mobile capture unit and a right infrared and/or ultrasonic sensor to measure the distance between the mobile capture unit and product displays, product shelves, and/or products on the right side of the mobile capture unit. The distance between the mobile capture unit 2000 and the product displays, product shelves and/or products provides feedback as to whether the mobile capture unit 2000 is too close or too far away from the object for optimum picture quality. For example, if the mobile capture unit is too far away or exceeds a predetermined amount, for example, five feet, or is turned greater than 15 degrees, an audible alert, such as a siren, and/or visual alert, such as a blinking light or alert on the user's interface may be triggered.

The one or more cameras 2003 may be positioned in many different ways in order to capture the best images possible. For example, the one or more cameras 2003 may be positioned one above the other on one or both sides of the mobile capture unit 2000. According to an embodiment, the one or more cameras 2003 are positioned so that the images of the product shelves, product displays and/or products are captured such that there is overlap to allow the vertical pictures to be picture “stitched” together, a process which will be further described below. FIG. 2E is a block diagram illustrating a mobile capture unit, according to an embodiment of the present disclosure. One or more cameras 2003a, 2003b, 2003c, 2003d, 2003e, 2003f, 2003g, 2003h, 2003i, 2003j, 2003k, 2003l, 2003m, 2003n, 2003o, and 2003p may be used in connection with the mobile capture unit 2000. According to an embodiment, the left and right cameras can be positioned vertically on two separate poles attached to the mobile capture unit. The left cameras 2003b, 2003c; 2003d, 2003e, 2003f, 2003g all face left and can be placed, for example, approximately twelve to fifteen inches apart vertically. The right cameras 2003h, 2003i, 2003j, 2003k, 2003l, 2003m, 2003n all face right and can be placed, for example, approximately twelve to fifteen inches apart vertically. A front facing and rear facing camera can be provided to obtain images of product displays, product shelves and/or products located at the front and rear of the mobile capture unit 2000. Angular mounted cameras, for example, left angled camera 2003a and right angled camera 2003h may be used on top of the mobile capture unit 2000 and may be angled down and to the left and right, respectively, to provide a view of, for example, vertical oriented refrigeration units, dump-bins, freezer bins, etc. Though imagery can be acquired from many camera devices known in the art, for example, fixed video or other digital cameras, and moving video or other digital cameras, according to an embodiment of the present disclosure, USB web cameras can be used. Here, cameras 2003a, 2003b, 2003c, 2003d, 2003e, 2003f, 2003g and 2003o are connected to the central processing unit 2005 through USB Hub 1 2015a and cameras 2003h, 2003i, 2003j, 2003k, 2003l, 2003m, 2003n and 2003p are connected to the central processing unit 2005 through USB Hub 2 2015b. According to an embodiment USB Hub 1 2015a and USB Hub 2 2015b are standard multi-port USB hubs, known to one of ordinary skill in the art, and are plugged into dedicated ports on the central processing unit 2005. The moving unit 2002 includes one or more wheels 2002c, one or more electric motors 2002a, and electronics and motor drive circuitry 2002b. The central processing unit 2005 controls the electronics and motor drive circuitry 2002b through a CPU interface 2008a. The battery 2012 and bar code scanner 2014 are connected to the docking station 2011 through the charging station 2013. The docking station 2011 is connected to the central processing unit 2005. A trigger device 2010 is connected to the central processing unit 2005 through a CPU interface 2008b and right sensor 2004a and left sensor 2004b are connected to the central processing unit 2005 through CPU interface 2008c. A user interface 2006 and navigation sensor 2009 linked to the central processing unit 2005 may also be provided.

The mobile capture unit may include a graphical user's interface or a user interface 2006, such as, for example, a touch-screen monitor and may be linked to and control multiple Universal Serial Bus (“USB”) devices via a powered USB hub or other interface devices. According to an embodiment, control software on the PC may control the motor speed and direction of each motor, allowing the PC to control the interface that people will use to drive the mobile capture unit through the retail store. The software may also track and record the movement of the mobile capture unit through the store. For example, a camera trigger wheel may enable the PC to measure forward and backward movement of the mobile capture unit, for example, by counting revolutions of the wheel. For image stitching, the PC may calculate the appropriate distance that the mobile capture unit may need to move before capturing the next image. For example, this calculation may be determined by the optimum horizontal and vertical overlap that is required for stitching pictures together to create a panoramic view from multiple images of retail store conditions. One or more digital and/or video cameras may be used with the mobile capture unit. According to an embodiment, the mobile capture unit may utilize lights to illuminate the displays in order to improve picture quality.

The mobile capture unit may unitize multiple infrared devices to measure and record the distance between the mobile capture unit and the displays, shelves, and/or other objects within each retail store.

FIGS. 2G-2I illustrate a mobile capture unit, according to alternative embodiments of the present disclosure. In FIG. 2G, the mobile capture unit 2000 comprises a moving unit 2002 (for example, four wheels), one or more cameras 2003, a user interface 2006, a bar code scanner 2014 and two or more doors that house the central processing unit 2005, a power source 2007 and printer 2016. The printer 2016 may be used for generating one or more reports. In FIG. 2H, the mobile capture unit 2000 comprises a moving unit 2002 (for example, four wheels), one or more cameras 2003, a user interface 2006, a bar code scanner 2014 and two or more doors (which may be transparent) that house the central processing unit 2005, a power source 2007 and printer 2016. In FIG. 2I, the mobile capture unit 2000 a moving unit 2002 (for example, four wheels), one or more cameras 2003, a user interface 2006, a bar code scanner 2014 and two or more doors that house the central processing unit, a power source and printer. In addition, there may be side doors of the mobile capture unit 2000.

According to an alternative embodiment of the present disclosure, the mobile capture unit may be a self-propelled robot that may be user controlled or automatically and independently controlled to roam a retail store using artificial intelligence to capture images of one or more retail store conditions. To distract the public from the real mission of the robot, the robot shell can be a marketing vehicle for the retailer. For example, the shell could be the store mascot and/or can contain video screen(s) on which advertisements can be displayed or broadcast. The screen may also be used by shoppers to ask questions such as product location, price checks, cooking recipes, etc. In addition to being able to know what areas of the store must be captured, the robot must also be able to automatically dock itself to recharge its batteries. The self-propelled robot may require an in-store navigation system, for example, a Global Positioning System (“GPS”) type technology or a technology where the robot looks at its surroundings and counts the revolutions on the wheels to “learn” the store and know the locations of the aisles. The robot may use both historical picture data and X-Y coordinates to learn not only where the aisles are, but where a specific location is for example, the bread aisle or the dairy aisle. For example, both data sets may be created by the robot and then linked to the processing location 2 so that the system would learn about a specific location in the store is, for example, the bread aisle. By finding many bread items at this location in the store, over time, the robot could learn the location and boundaries of the bread section by mapping the X-Y coordinates to the UPCs it finds in the images. The product hierarchy within the library 24 allows the sections to be identified without any data entry. For example, if 90% of all the UPCs in the image are within the bread section of the library 24, then that location within the store can be coded as “Bread” until the actual data contradicts that mapping.

According to an embodiment of the present disclosure, the mobile capture unit 30 may utilize Radio Frequency Identification (“RFID”) to automatically navigate the store.

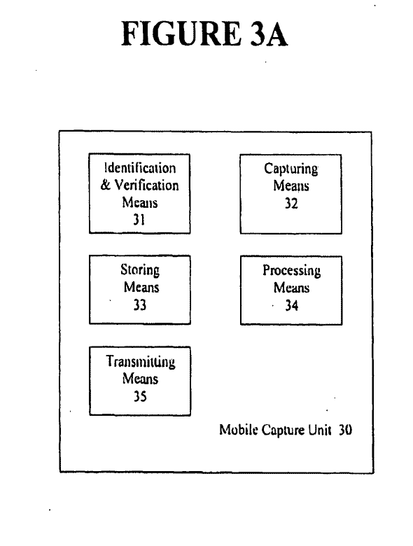

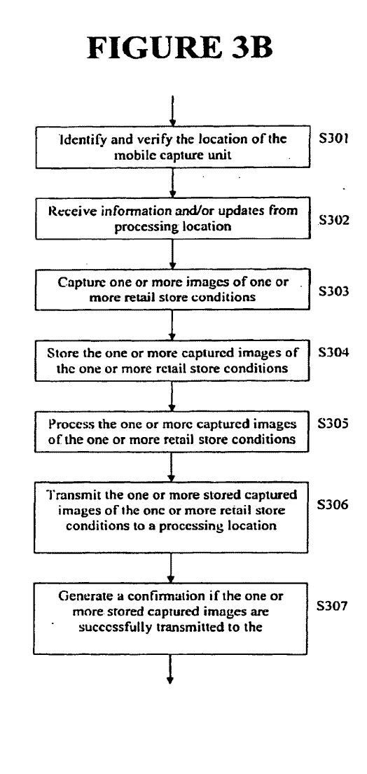

The mobile capture unit, according to an embodiment of the present disclosure, will be discussed below with reference to FIGS. 3A and 3B. The mobile capture unit 30 may include identification and verification means 31, capturing means 32, storing means 33, processing means 34 and transmitting means 35. The identification and verification means 31 identifies and verifies the location of the mobile capture unit 30 (Step S301). For example, while outside a retail store, the mobile capture unit 30 can use GPS technology to identify and confirm the retail store location. The mobile capture unit 30 may receive information and/or updates from the processing location. (Step S302). The capturing means 32 captures the one or more images of one or more retail store conditions (Step S303). The storing means 33 temporarily stores the one or more captured images of the one or more retail store conditions for a predetermined time (Step S304). The processing means 34 processes the one or more captured images of the one or more retail store conditions (Step S305). The transmitting means 35 transmits the one or more stored captured images of the one or more retail store conditions to the processing location 2 (Step S306). A confirmation may be generated indicating whether or not the one or more captured images were successfully transmitted to the processing location 2 (Step S307).

The capturing means 32 of the mobile capture unit may include one or more digital cameras, video cameras, web cameras etc. For example, multiple low-cost web cameras could be mounted in a high and/or low position on a mobile capture unit to get a flat and complete image capture of a shelf. The cameras may be positioned to take pictures at the proper angle of, for example, end-cap displays, in-aisle displays, and standard gondolas (from the floor up to eight feet in height). Fish-eye lenses may also be used to capture images of the entire display and shelf where the aisles are very narrow. The mobile capture unit 30 may also include a camera that is not fixed, for example, to the portable unit or cart. This will give flexibility to use the camera for image acquisition that would be difficult to capture with a camera that is mounted on the portable unit or cart. For example, coffin freezers, freezers with signage or frost on the doors, planogram sections with displays in front of the shelf, etc. may be problematic. According to an embodiment of the present disclosure, the mobile capture unit may utilize motion detector technology to start and stop the image capturing.

The mobile capture unit may contain means for connecting to the Internet, for example, a wireless Internet connection. The one or more captured images are transmitted to the processing location 2 in different ways depending on the availability of an Internet connection. If a wireless Internet connection is not available in the retail stores where the unit is used, the mobile capture unit 30 may transmit the one or more captured images all together in a batch process using a high speed land line or DSL Internet connection. If the upload process is interrupted in the middle of transmitting the one or more captured images, the process should restart where it was interrupted. For example, if the upload process fails on the 350^{th} image out of 400 images, the up-load should re-start on the 351^{st} image. Similarly, if the connection with the processing location 2 is lost, the mobile capture unit 30 should be able to automatically re-establish a connection. According to an embodiment of the present disclosure, compression technology may be utilized with the image transfer to minimize the amount of data to be uploaded and prior to transmission, the images should be scanned for potential computer viruses, worms, etc.

FIG. 2F is a flow chart illustrating the step of processing the one or more captured images, according to an embodiment of the present disclosure. The one or more images captured by the mobile capture unit may be rotated (Step S2008). For example, if the captured images are on the side, they can be rotated by 90 degrees. The one or more captured images may be converted into a single file format (Step S2009). For example, the one or more images can be converted from .bmp into .jpg or any other image format, including, but not limited to, .tif, .gif, .fpx, .pdf, .pcd, or png, etc. According to an embodiment, all temporary files may be deleted at this point in the process to conserve the amount of hard disk or other storage space. The one or more rotated captured images may be assembled into one or more sets (Step S2010). The one or more sets can be stitched together to create one or more images (Step S2011). For example, the side picture sets may be stitched vertically. The one or more stitched images can then be transmitted to a processing center (Step S2012). For example, the mobile capture unit can confirm that an Internet connection is available and then put the one or more stitched images into an FTP queue. Each image can then be compressed and transmitted to the processing location. Once all the images have been transmitted to the data center, the mobile capture unit can archive all the transmitted images, delete all temporary files and clean the system.

However, if an Internet connection is available in the retail store, for example, if the mobile capture unit 30 is a cart stationed permanently in the store, the mobile capture unit 30 can automatically send the captured images to the processing location 2. For example, the mobile capture unit 30 can initiate the transmission of the one or more captured images to the processing location 2 or the processing location 2 can request that the mobile capture unit 30 transmit to it the one or more captured images. If the transmission process is interrupted, the system should be able to automatically recover, for example, the mobile capture unit 30 should automatically resend any images that are not usable because of transmission errors.

To minimize the risk of theft of the mobile capture unit, especially for the cart unit described above, if the mobile capture unit is taken within a certain number of feet of an exit, an audible alert can sound and/or an email alert can be transmitted to a store manager or other authority. The mobile capture unit may also request that the operator enter a user identification and/or password and may take a picture of the person utilizing the mobile unit or cart.

According to an embodiment of the present disclosure, the mobile capture unit, for example, the cart unit can control the capturing of images to insure overlap for the virtual walk-through viewer feature, which will be further discussed below. By using the cart unit, all the pictures can be taken from the same height with enough overlap so that they could be processed in the correct sequence. For example, triggering device 2010 in the system could control the timing of the picture captures.

One or more auditors can follow a daily store audit schedule and visit one or more retail stores, using the mobile capture unit 30 to capture one or more images of the retail store conditions for each store. The daily store audit schedule can be transmitted from the processing location 2 to the mobile capture unit 30 and can be displayed on the mobile capture unit's 30 screen.

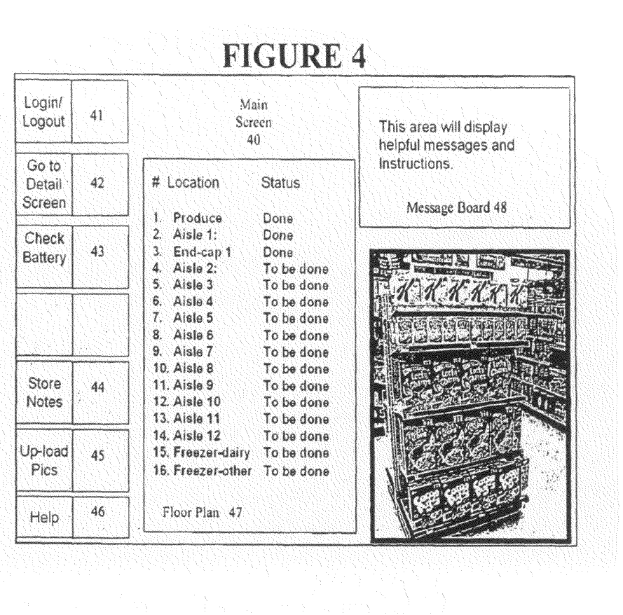

FIG. 4 is a block diagram illustrating the main screen of the mobile capture unit 30. Outside of a store to be audited, an auditor powers up the mobile capture unit 30 and touches or clicks “Log In/Log Out” 41 located on the main screen 40 of the mobile capture unit. The auditor can enter his username and password in order to access the system. Any changes that are made to the daily audit schedule or any other information, can be immediately transmitted and retrieved by the auditor through a message board 48. Any notes about the particular store can be accessed through “Store Notes” 44. After the auditor logs in, the mobile capture unit 40 can then verify and identify its location by using, for example, standard GPS technology and a database of retail locations. Once the mobile capture unit has identified its location, it can retrieve that retail store's floor plan configuration from the processing location 2. The floor plan configuration contains, for example, the number of aisles, freezers, fixtures, and other floor plan details. Using this information, the mobile capture unit 30 displays a floor plan 47 containing a listing of all the areas that the auditor needs to capture images of and their status 47 on its main screen 40. According to an alternate embodiment of the present disclosure, the actual graphical floor plan can be obtained and displayed. Each section may be color-coded to help the auditor quickly see what images are already captured and what images still need to be captured. According to an embodiment of the present disclosure, the areas that need to be captured will be displayed in an order to optimize the user's movement for capturing the data. For example, the first section may be near the entrance to minimize the down-time of the auditor. The suggested order/sequence on the main screen 40 may follow the typical way a person would walk through the store performing a standard store audit. At any time, the auditor can check the battery life of the mobile capture unit 30 by touching or clicking on “Check Battery” 43. After all images are captured, they may be uploaded to the processing location 2 by touching or clicking on “Up-load Pics” 45.

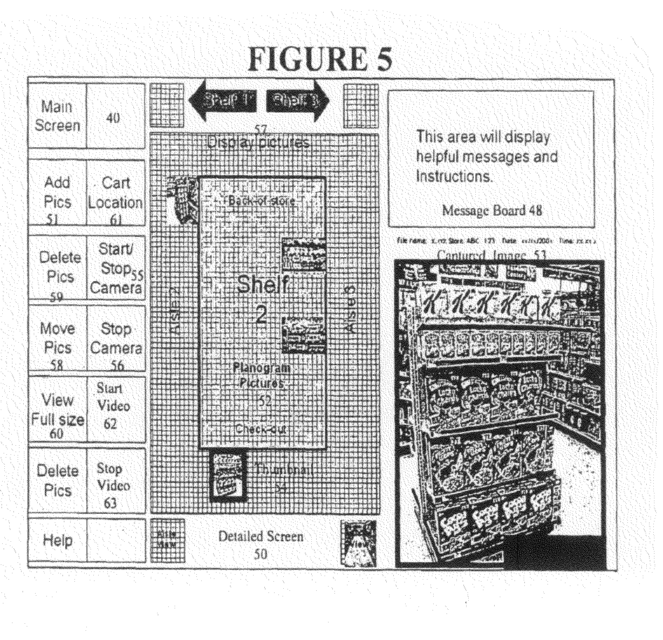

Auditors can use the mobile capture unit 30 to audit display activity and review in-store retail conditions by using, for example, a planogram. A planogram is a diagram, drawing or other visual description of a store's layout, including placement of particular products and product categories. To capture one or more images of the retail store conditions, the auditor can touch or click any of the locations in the floor plan 47 and touch or click “Go To Detail Screen” 42, for example, if the auditor touches or clicks the fourth entry, “Aisle 2,” the detailed screen 50 of FIG. 5 will be displayed. The detailed screen 50 helps the auditor capture images by using a planogram 52. The planogram 52 detailing the layout of the aisle is displayed on the detailed screen 50. By touching or clicking “Add Pics” 51, the auditor can commence the capture of images of retail store conditions. After capturing an image, the image is automatically downloaded to the storage area of the mobile capture unit 30. To add an image in its appropriate location in the planogram 52, the auditor could touch the screen at the appropriate location, causing the image to appear as a large image 53 on the right side of the screen, and as a smaller thumbnail 54 in the aisle. If the auditor puts the image in the wrong location, he/she can move the image by touching or clicking “Move Pics” 58 and touching the correct location on the screen where the image should appear. If the image is not acceptable, the auditor can delete the image by touching or clicking on “Delete Pics” 59 and retake the image. The auditor can also view the full size image by touching or clicking on “View Full Size” 60.

According to an embodiment of the present disclosure, the auditor can capture the entire length of the aisle by switching to a mobile capture unit 30 with a fixed camera, such as the cart unit described above. The cart unit may have one camera or it may have multiple cameras on two opposite sides of the unit to maximize the ability of the cart to take quality pictures of the retail store conditions as the cart is pushed down an aisle. The auditor can touch or click on “Start Camera” 55 or and touch or click the planogram 52 area in the location where the image capture would begin. The auditor can then push the mobile capture unit 30, for example, the cart unit, down the aisle, capturing the one or more images of retail store conditions in that aisle. The auditor can then touch “Stop Camera” 56 and/or the location on the planogram 52 at the end of the aisle, indicating that the image capture for that aisle is complete. The auditor can either go back to the main screen 40 by touching or clicking on “Main Screen” or can continue capturing the entire length of all the aisles by touching or clicking on the arrows 57 moving the auditor to the next or previous aisle. The arrows 57 may also move the auditor to other locations in the store, for example, the front of the store, the back of the store, the check-out area of the store, the produce area of the store, etc. Alternatively, the auditor can touch or click “Start Video” 62 and/or the location on the planogram 52 where the image capture would begin. The auditor can then push the mobile capture unit 30, for example, the cart unit, down the aisle, capturing the one or more images of retail store conditions in that aisle. The auditor can continue moving the mobile capture unit 30 up and down adjacent aisles until the image capture is completed by touching or clicking on “Stop Video” 63.

The storing means 33 temporarily stores the one or more captured images of the one or more retail store conditions for a predetermined time. For example, the images may be stored and stitched together in various ways to organize and prepare the images for the comparing or image recognition step. In addition, stitching the images together helps to eliminate duplicates that are caused by the possible overlap between sequential images of a retail store and across one or more cameras taking those images. Moreover, image stitching may also provide a raw database for a virtual walkthrough viewer feature, as well as for ad-hoc picture viewing. According to an alternate embodiment, the picture stitching could be performed after the transmission of the captured images or as the images are being captured.

The original source pictures that are stitched together to create larger pictures for the virtual-store walk through can be deleted after the new picture is created and passes quality assurance tests. If a video stream is used to capture the original source for pictures for stitching, then the video stream will be deleted as soon as the individual frames have been isolated, extracted, format converted and stitched together. The final processed images should be stored for a predetermined time in the database of the image capture unit 21. For example, images may be retained for one week and then replaced by the images of the current week. According to an embodiment of the present disclosure, each image can be stored as an individual file.

Prior to transmission, the mobile capture unit 30 may process the one or more captured images. Specifically, the mobile capture unit 30 can determine whether there are any problems with the images, such as missing sections and/or errors in picture mapping, for example, whether there was an obstacle between the mobile capture unit 30 and the shelf or display, whether the image is distorted because the mobile capture unit 30 was at a bad angle relative to the shelf or display, whether the lens is dirty or out of focus, whether the image is blurred because the mobile capture unit 30 was moving, whether there is an information gap in the image because it does not overlap with the last picture, whether the image is a duplicate of images already taken or overlaps with prior images already taken, whether there is a hardware failure of some type, making the images unusable, whether there is frost on the window of a vertical freezer or refrigerator, preventing the mobile capture unit 30 from obtaining a clear picture of the products, etc. If there are any missing images or errors, such as the ones described above, the auditor can retake those images or the mobile capture unit can automatically retake the images. Moreover, all images may be rotated to the correct orientation (for example, image may be shown on the screen and the auditor can override the rotation if it is incorrect), automatically enhanced for color, brightness, hue, etc. (for example, could be done in batch mode before the images are compressed), checked for focus (for example, image may be displayed on the screen so the auditor can decide whether or not to reject it), and/or cropping images from displays so that the product on the shelf can be correctly identified by the image recognition module 23. The operator of the mobile capture unit 30 can visually review the processed virtual-store walk through images and approve the picture quality before the next set of shelf pictures are captured, according to an embodiment of the present disclosure. For example, if the products contain a very small label, the auditor can remove one of the products from the display and make the label more visible before taking the image.

The processing means may also associate the one or more captured images with related information, such as date, time and location information, including, but not limited to the following: Store Name, Store Location, Display Location, Display Type, Date and Time of Image Capture. According to an alternate embodiment, the processing performed by the image capture unit 21 may be performed after the transmission of the captured images by the processing location 2.

The captured images and related information may be transmitted to a processing location where they may be stored, further processed and converted into useful information.

### Processing Location

After the one or more captured images and related information are transmitted, they are received at the processing location 2. The processing location 2, which may be centralized, includes an image recognition module 23, library 24, repository 25, reporting engine 26, external data repository 27 and exception editing mechanism 28.

Once the one or more captured images and related information are received, they are stored in a repository 25. Not all of the captured images will be permanently stored. For example, duplicates, bad images, etc. will be discarded. According to an embodiment of the present disclosure, the one or more capture images may be saved as raw images in a MS-SQL database for quick access by store, location, date, time and orientation. The one or more captured images may also be stored in a back-up location, by using, for example, data mirroring or some other form of back-up software. To minimize data storage, images should be captured and stored at a minimum resolution needed for the image recognition module. A watermark may be imposed onto each image in a way that does not degrade the picture in any way for image recognition processing. Because of the large storage requirements each day, final pictures may be archived off-line.

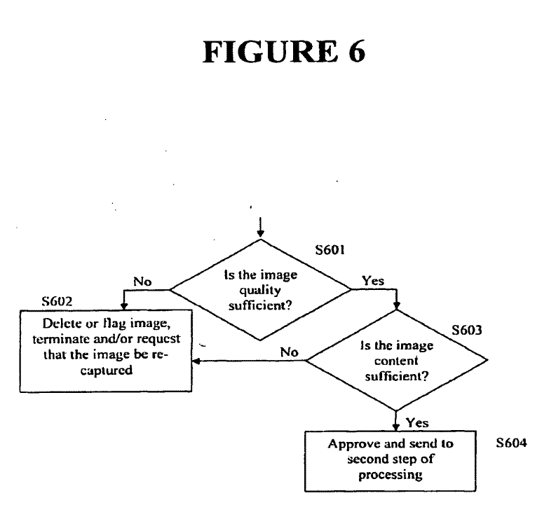

FIG. 6 is a flow chart illustrating the step of processing by the image recognition module, according to an embodiment of the present disclosure. This step may be performed by either the image capture unit 21 or the image recognition module 23. The image recognition module 23 processes the one or more captured images by determining whether the image quality and image content for each images is sufficient. For example, the image recognition module 23 can first determine if the image quality is sufficient (i.e., focusing, distortion, etc.) (Step S601). If the image recognition module 23 determines that the image quality is not sufficient (No, Step S601), it can delete or flag the image, terminate, or request that the image be re-taken (Step S602). On the other hand, if the image recognition module 23 determines that the image quality is sufficient (Yes, Step S601), the image recognition module 23 can then determine whether the overall image content is consistent with its coded location (Step S603) (i.e., if the image is coded as a shelf view, whether or not there is a display unit in the image). If the image recognition module 23 determines that there are obstacles in the image (No, Step S603) (i.e., people, shopping carts, or any other obstacle blocking the view of the shelf or display), can delete or flag the image, terminate, or request that the image be re-taken (Step S602). However, if image recognition module 23 determines that the image content is sufficient (Yes, Step S603), the image will be approved and sent to the second step of processing (Step S604). According to an embodiment, if the image recognition module 23 determines that the images contain a distant view of products on a different shelf not under analysis, the image recognition module 23 may exclude them from analysis by cropping the image to remove them. According to an alternative embodiment, the image recognition module will utilize a hand-held barcode reader in the store to identify products. The person operating the mobile capture unit 30 (for example, by pushing or driving it) will use a hand-held barcode reader to electronically record the UPC code of each product being displayed in the retail store, in addition to recording the UPC of products requiring follow-up action, such as an out-of-stock condition.

The second step of processing comprises the image recognition module 23 comparing the one or more captured images with a library 24, for example, a CPG product picture database or a third party vendor library, to identify the one or more retail store conditions in the one or more captured images and obtain identification information about the retail store conditions, for example, store number, image date/time, UPC, and/or other detailed information describing the precise location of the product in the store, etc. This allows for the creation of a database of information on the retail conditions by store, including detail on what products were found in each store and their location within the store. For example, the image recognition module 23 can compare each retail store condition in each captured image to the library 24 and identify the products that appear in each captured image (for example, by trying to identify each UPC found within the image). The processing may be split across multiple central processing units (“CPUs”), so that each CPU will complete processing prior to when the next report is due. To speed up processing time, the image recognition module 23 may only use the relevant part of the library 24 for each image. For example, if the image recognition module 23 is only analyzing displays, it can use the 5,000 UPCs or so that are typically on end-of aisle displays or if it is only analyzing images in the canned goods section, it won't analyze the frozen product images in the library 24.

The library 24 may include UPCs, shelf tags, product images, and/or an other information that would allow the image recognition module 23 to identify the one or more retail store conditions in the one or more captured images. For example, the cosmetics department may have very small products where the only major difference between the UPCs in color. Multiple passes may have to be performed on each image in order to complete the image recognition. For example, there are some categories where only a small amount of text on the product may distinguish between different UPCs. These types of UPCs could be flagged in the library. If a flagged UPC is located, the image would be processed again using different business rules. For example, if just one of these products is found a picture, additional pieces of information may be used to complete the identification process; such as the information on the shelf tag, including description, UPC bar code and related signage. For a display, information on the cardboard box and/or shipper would be used.

According to an embodiment of the present disclosure, the image recognition module 23 can find specific signage and in-store banners by comparing the one or more captured images to a third party vendor library.

After the one or more retail store conditions in each image are identified and related information obtained, this information is stored in the database 25. For example, the following information may be stored in the database for each retail store condition identified: Date of Image Capture, Time of Image Capture, Picture Identification, Store Number, User Identification, Floor Plan, Store Location, Fixture, Fixture View, Sequence Position, Processing Location Section, UPC, Quantity, Merchandising Identification, X/Y Position In Image, Date/Time Processed, Software Version, etc. For example, the Date of Image Capture relates to the date the picture was taken and the Time of Image Capture relates to the time the picture was taken, which can be converted to local time for the relevant time zone. The Picture Identification may be a file name or an identification tag assigned to the picture when it is uploaded to the processing location 2. This identification could be used in ad-hoc reporting mode to obtain the image. The Store Number is a number ID assigned to every store in the United States. A commercially available database exists, where the physical location of every retail store within the United States is identified by global latitude and longitude. This database also contains other information about each retail location, such as the retail name. This information can be used to confirm and record the physical location and retail source of the retail audit of the mobile capture unit. The User Identification relates to the identification of the auditor or operator of the image capture unit 21. The Floor Plan is a field that may be used if the software maps the store fixtures to an actual floor blueprint. One or more data fields may have to be used to identify the location in the store. The Fixture field is populated with the image where the image capture begins. The Fixture View field is populated with the image where the image capture ends. The Sequence Position relates to an internal sequence number that helps stitch pictures together into local groupings (i.e., the entire aisle). The Processing Location Section may be a calculated field by the image recognition module 23 that can estimate or calculate the section by using the UPC and the physical location. The UPC is the UPC of the product found in an image. There will be one record in the table for each UPC found in the image. The Quantity field relates to the number of UPCs that are found in the picture. For example, if the shelf has three facings of a product, then the quantity would be 3. The Merchandizing Identification is a field that may be used to identify shelf labels and in-store signage, such as shelf-talkers and banners. The X/Y Position in the image relates to the location in the image that the product was found. For example, this may be used to identify where on the shelf the product was located and whether or not this was in accordance with corporate directives. Another use of the X/Y position could be to research and troubleshoot data accuracy issues identified by the client. The Date/Time Processed is the date the image recognition module 23 processed the picture and identified the particular product in this image. The Software Version is the version of the image recognition software used by the image recognition module 23 that identified the product.

The reporting engine 26 can provide access to any captured image in any retail store at any location within the retail store for any given time. For example, through an ad-hoc image viewer, individual images may be pulled up one at a time using a filter. The filter allows the user to select search parameters, such as date range, time of day, store, products, etc. When looking at an individual image, the user can flip forward or backward in time to see what the same location looked like or will look like over time. When looking at a specific image, the user can look at the same identical location on the planogram across multiple stores. Through a virtual store walk through viewer, images of retail store conditions can be viewed sequentially in either two or three dimensions. The viewer can pull up images for one or more retail store conditions and “walk through” each image. If there are duplicate images of the same store fixture and location, the viewer can either filter out or offer a different viewing option for the duplicate images. If there are gaps in the images, the viewer may fill in the gap with standard wall-paper.

The one or more captured images and related information are analyzed and one or more summary reports and/or alerts are generated. Automated alerts and reports of in-store retail conditions may be automatically sent to clients detailing information by store, date, time and product. The alerts are configurable and table-driven, allowing the processing location 2 to easily set up business rules that will trigger the alerts. For example, if the store is past-due for sending captured images, if the store fails to display a specific product, if products not authorized for merchandising are found on the display, or any other user defined alert. Alerts may be transmitted to computers, laptops, personal digital assistants, cell phones, and any other hand-held device. Web links may be embedded within the message, so that the recipient can go directly to a supporting report or image if the device has browser support. When possible, alerts are combined so that an individual user does not receive a large amount of related emails in a short time frame.

Reports may run at summary levels that include a store, zone, chain, or any other location. The reports may report results by location within the store (i.e., end cap, aisle, etc.). For products on display, the reports may include a recap of the number of days the product was on display, the UPC, description, brand, size, etc. According to an embodiment of the present disclosure, retail point of sale data may be integrated with the retail store conditions to provide near real-time post promotion analysis. When point of sale data is integrated by the processing location 2, the reports may include information concerning one or more of the following: regular price, sale price, base volume, actual volume, lift, item UPC, brand description, size, category recap, category base, category actual, category lift, category target percent profit margin, category actual percent profit margin, participating promoted brand recap, etc.

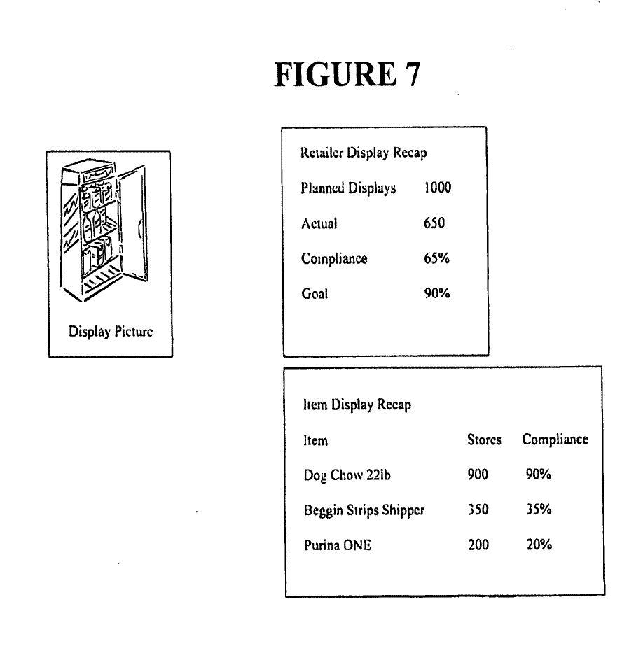

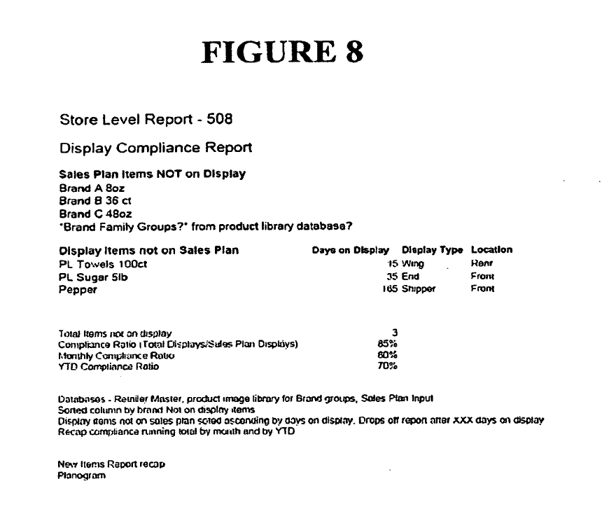

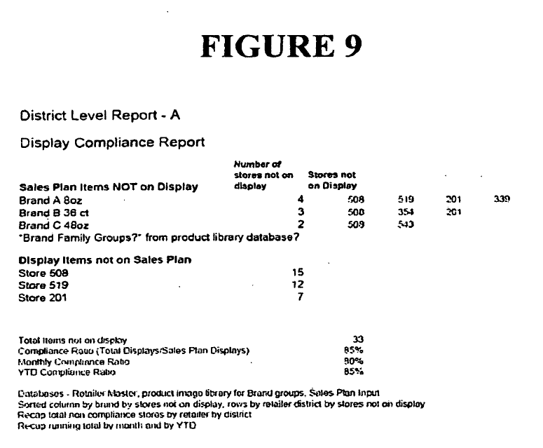

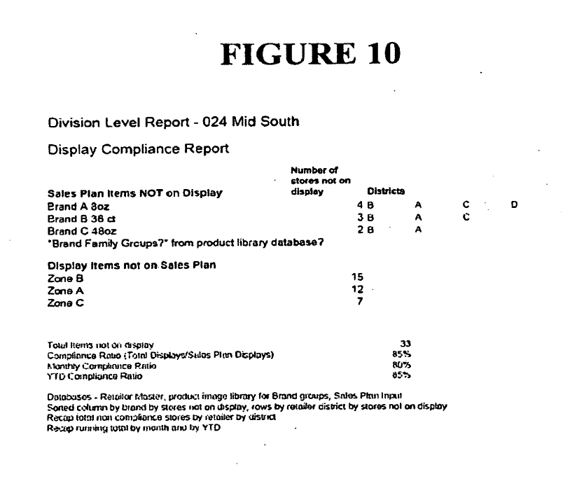

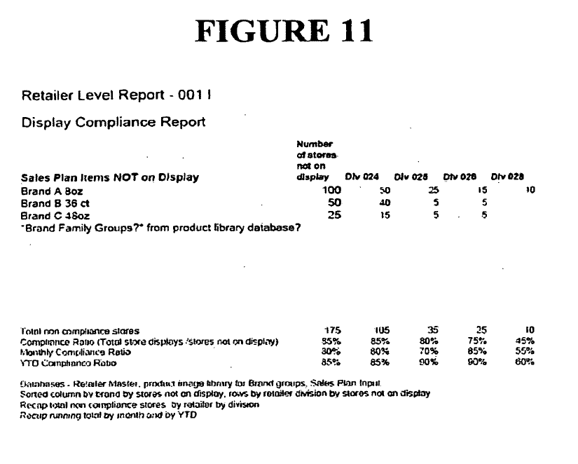

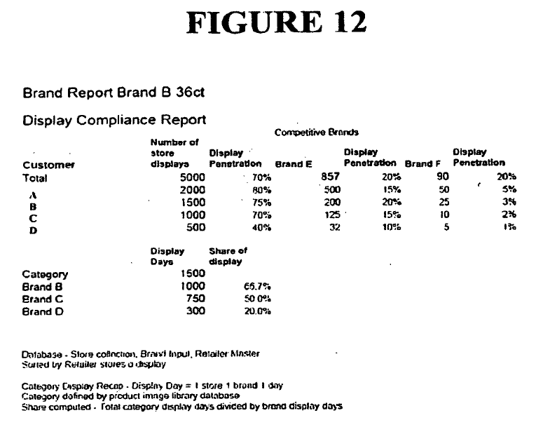

FIGS. 7-12 show sample reports generated by using the method for measuring retail store display and shelf compliance, according to one embodiment of the present invention. For example, FIG. 8 shows a report showing display and shelf compliance by store, FIG. 9 shows a report displaying display and shelf compliance at the district level, FIG. 10 shows a report displaying display and shelf compliance at the division level, FIG. 11 shows a report displaying display and shelf compliance at a retailer level, and FIG. 12 shows a report displaying display and shelf compliance by competitive brand. Each report may be generated by using the data stored in the repository 25 and external data from one or more external data repositories 27. For example, information relating to stores may be stored in an external data repository 27 comprising a listing of all stores, including a unique retail store identifying number, name, description, address, parent company, class of trade, format and other information and attributes. Information relating to parent companies may be stored in an external data repository 27 comprising a listing of all parent companies, including a description, address and/or any other information. This allows for a roll-up of information of individual store banners to a parent company total. Information relating to UPCs may be stored in an external data repository 27 comprising a listing of all products, including UPC description, product dimensions, product images from several angles, and other attributes. Information relating to brands may be stored in an external data repository 27 comprising a listing of all brands, including description, category, manufacturer, etc. Information relating to categories and manufacturers may also be stored in the external data repository 27.

A computer storage medium, including computer executable code for measuring retail store display and shelf compliance, according to one embodiment of the present disclosure includes, code for capturing one or more images of one or more retail store conditions, code for associating the one or more captured images with related information, code for transmitting the one or more captured images and the related information to a processing location for storage and processing, code for receiving the one or more captured images and the related information at the processing location and storing the one or more captured images and related information in a repository, code for processing the one or more captured images, code for comparing the one or more retail store conditions in the one or more captured images with a library to identify the one or more retail store conditions and obtain identification information about the one or more retail store conditions, code for storing the one or more identified captured images and identification information for the one or more retail store conditions in the repository, code for analyzing the one or more retail store conditions in the one or more captured images and identification information, and code for generating one or more summary reports or one or more alerts based upon the analysis.

The code for capturing one or more images of one or more retail store conditions, according to one embodiment of the present disclosure further comprises, code for identifying and verifying the location of an apparatus, code for capturing one or more images of one or more retail store conditions, code for storing the one or more captured images of the one or more retail store conditions, code for processing the one or more captured images of the one or more retail store conditions, code for transmitting the one or more captured images of the one or more retail store conditions to a processing location, and code for generating a confirmation indicating whether the one or more captured images of the one or more retail store conditions were successfully sent to the processing location.

Numerous additional modifications and variations of the present invention are possible in view of the above-teachings. For example, the method and system of the present disclosure can be utilized in the automotive industry to take close up images of auto-parts bins and shelves, in public and private libraries to take close up images of book stacks, in connection with homeland security to capture the sides and under-sides of trucks as they pass through security check-points, and in warehouses to take close up images of contents stored there.

What is claimed is:

1. A method for measuring retail store display and shelf compliance, comprising:
(a) verifying a starting location of a mobile image capture unit;
(b) determining a movement distance for the mobile image capture unit;
(c) moving the mobile capture unit the determined movement distance;
(d) capturing one or more images of one or more product displays, product shelves or products with the mobile image capture unit;
(e) determining if there are more images to capture;
(f) repeating steps (b) through (e) if it is determined that there are more images to capture; and
(g) processing the one or more captured images if it is determined that there are no more images to capture.

2. The method of claim 1, wherein the one or more images of the one or more product displays, product shelves or products are captured while the mobile capture unit is moving.

3. The method of claim 1, further comprising determining an object distance between the mobile capture unit and the one or more product displays, product shelves or products to be captured.

4. The method of claim 3, wherein an alert is provided if the determined object distance exceeds a predetermined amount.

5. The method of claim 1, wherein the mobile capture unit is moved by one or more electric motors coupled to one or more wheels.

6. The method of claim 1, wherein a central processing unit controls the moving of the mobile capture unit.

7. The method of claim 1, further comprising reading and storing the bar codes of one or more products.

8. The method of claim 1, wherein the movement distance is determined based on overlap in the one or more images to be captured.

9. The method of claim 1, wherein the movement distance is automatically determined by a central processing unit.

10. The method of claim 1, wherein the processing step comprises:
(a) assembling the one or more captured images into one or more sets;
(b) stitching the one or more sets together to create one or more images; and
(c) transmitting the one or more stitched images to a processing center.

11. The method of claim 10, further comprising converting the one or more captured images into one or more different file formats.

12. The method of claim 10, wherein the one or more stitched images are compressed before transmission to the processing center.

13. The method of claim 10, wherein the one or more captured images and one or more stitched images are deleted after they are transmitted to the processing center.

14. An apparatus for measuring retail store display and shelf compliance, comprising:
(a) a unit for determining a movement distance for the mobile image capture unit;
(b) a unit for moving the mobile capture unit the determined movement distance;
(c) one or more cameras for capturing one or more images of one or more product displays, product shelves or products with the mobile image capture unit;
(d) a central processing unit for determining if there are more images to capture and processing the one or more captured images;
(e) a power source for the mobile capture unit.

15. The apparatus of claim 14, wherein the one or more images of the one or more product displays, product shelves or products are captured while the mobile capture unit is moving.

16. The apparatus of claim 14, further comprising a unit for determining an object distance between the mobile capture unit and the one or more product displays, product shelves or products to be captured.

17. The apparatus of claim 16, wherein an alert is provided if the determined object distance exceeds a predetermined amount.

18. The apparatus of claim 14, wherein the mobile capture unit is moved by one or more electric motors coupled to one or more wheels.

19. The apparatus of claim 14, wherein the central processing unit controls the moving of the mobile capture unit.

20. The apparatus of claim 14, further comprising a bar-code scanner for reading and storing the bar codes of one or more products.

21. The apparatus of claim 14, wherein the movement distance is determined based on overlap in the one or more images to be captured.

22. The apparatus of claim 14, wherein the movement distance is automatically determined by the central processing unit.

23. The apparatus of claim 14, wherein the central processing unit rotates the one or more captured images; assembles the one or more captured images into one or more sets; stitches the one or more sets together to create one or more images; and transmits the one or more stitched images to a processing center.

24. The apparatus of claim 23, wherein the central processing unit converts the one or more captured images into one or more different file formats.

25. The apparatus of claim 23, wherein the one or more stitched images are compressed before transmission to the processing center.

26. The apparatus of claim 23, wherein the one or more captured images and one or more stitched images are deleted after they are transmitted to the processing center.

27. The apparatus of claim 14, further comprising a navigation sensor for identifying the location of the mobile capture unit.

28. The apparatus of claim 27, wherein the navigation sensor utilizes radio frequency identification, global positioning systems, digital compass devices, analog compass devices or ultra-violet sensors to identify the location of the mobile capture unit.
